(19) United States
(12) Patent Application Publication
(10) Pub. No.: US 2017/0239124 A1
(43) Pub. Date: Aug. 24, 2017

(54) SUPPORT APPARATUS FOR A SUBJECT AND A METHOD FOR SUPPORTING A SUBJECT IN A SUBSTANTIALLY INVERTED STATE

(71) Applicant: MIPINEYE LIMITED, Dublin 13 (IE)

(72) Inventor: Brian Patrick CUNNINGHAM, Dublin 13 (IE)

(73) Assignee: MIPINEYE LIMITED, Dublin 13 (IE)

(21) Appl. No.: 15/518,842

(22) PCT Filed: Oct. 14, 2015
(86) PCT No.: PCT/IE2015/000015

§ 371 Date: Apr. 13, 2017

(30) Foreign Application Priority Data
Oct. 14, 2014 (IE) S2014/0261

(51) Int. Cl. A61H 1/02

(52) U.S. Cl. CPC A61H 1/0229; A61H 2201/1614; A61H 2201/1619; A61H 2203/0493

(57) ABSTRACT

Apparatus (60) for supporting a subject (2) in an inverted state comprises a ground engaging plinth (8) and a support platform (12) pivotally coupled to the plinth (8) about a first pivot axis (15) so that the support platform (12) is pivotal between a first state with a subject (2) in a supine state on the support platform (12) and a second state with the subject (2) inverted on the support platform (12). The subject is supported in the inverted state on the support platform (12) by shoulder engaging elements (24), and is secured to the support platform (12) by a torso strap (35). A foot engageable element (77) connected to a weight carrying bar (84) through connecting members (79,82) extending through an elongated slot (80) in the support platform (12) allows leg and abdominal muscles to be exercised by urging the foot engageable element (77) in the direction of the arrow A against weights (85) carried on the weight carrying bar (84). A carrier element (81) slideable on a guide bar (83) guides the foot engageable element (77). Handgrips (86) are connected by steel cables (87) around pulleys (88,89,90,91) to the weight carrying bar (84) for facilitating exercising of arm, shoulder, chest and back muscles.

The present invention relates to apparatus for supporting a subject, and in particular, to apparatus for supporting a subject in a substantially inverted state. The invention also relates to a method for supporting a subject in a substantially inverted state.

It is known that by inverting a subject increases the efficiency with which the lungs of the subject utilise inhaled oxygen to oxygenate the blood of the subject. When the lungs of a subject are in an inverted state, the alveoli in the base of the lungs, which when a subject is inverted becomes the highest point of the interior of the lungs, receive more of the inhaled oxygen than is the case when the subject is standing upright on his or her feet, and thus, the efficiency of oxygenation of the blood of a subject in the inverted state is increased. By increasing the efficiency with which the blood is oxygenated, the organs of the body of a subject receive more oxygen when the subject is inverted. Since it is known that the brain requires approximately 20% of all oxygen inhaled, increasing the efficiency of oxygenation of the blood of a subject by the lungs increases the availability of oxygen to the brain. This significantly increases the neurological responses of the brain, and the brain functions significantly more efficiently. While standing on one's head or one's hands would increase the efficiency with which the lungs oxygenate blood from inhaled oxygen, standing on one's head or one's hands becomes uncomfortable relatively quickly, and thus many of the benefits of inverting the body of a subject by standing on one's head or one's hands are negated.

There is therefore a need for a support apparatus for supporting a subject, and in particular, for supporting a subject in a substantially inverted state.

The present invention is directed towards providing apparatus for supporting a subject in a substantially inverted state, and the invention is also directed towards providing a method for supporting a subject in a substantially inverted state.

According to the invention there is provided apparatus for supporting a subject in a substantially inverted state, the apparatus comprising a support element comprising a pair of spaced apart shoulder engaging elements, the shoulder engaging elements being configured to support the subject in the substantially inverted state with the shoulder engaging elements substantially bearing the weight of the subject.

Preferably, the shoulder engaging elements define a neck accommodating space therebetween to freely accommodate the neck of the subject, and advantageously, the shoulder engaging elements define a head accommodating space therebetween for freely accommodating movement of the head of the subject, and ideally, for accommodating side to side movement of the head of the subject.

Preferably, each shoulder engaging element defines a shoulder accommodating recess for engaging and accommodating a corresponding one of the shoulders of the subject, and preferably, each shoulder engaging element defines the corresponding shoulder accommodating recess with the support element.

In one aspect of the invention each shoulder engaging element comprises an L-shaped member, having a first leg thereof extending from the support element, and a second leg thereof extending from the first leg parallel to and spaced apart from the support element, so that the L-shaped member defines with the support element the corresponding shoulder accommodating recess. Ideally, each shoulder engaging element is configured on the support element so that the corresponding one of the shoulders of the subject is embraced in use by a combination of the corresponding shoulder engaging element and the support element with the support element extending adjacent one of the back and the front of the body of the subject, and the second leg of the corresponding shoulder engaging element extending along the other one of the front and back of the shoulder of the subject.

Preferably, the shoulder accommodating recesses defined by the respective shoulder engaging elements define a shoulder axis which extends transversely of the support element, and preferably, the shoulder engaging elements are located on the support element with the shoulder axis defined by the shoulder accommodating recesses extending in use substantially parallel to a line joining the shoulders of the subject.

In another aspect of the invention a securing means is provided for securing the subject to the support element, and preferably, the securing means comprises torso securing means engageable with the torso of the subject for securing the torso of the body of the subject to the support element. Advantageously, the securing means comprises a torso engaging securing strap extending from the support element and configured for engaging the torso of the subject. Preferably, the securing means comprises at least one leg securing means, which advantageously, comprises at least one, and preferably, a pair of leg engaging straps for securing the legs of the subject to the support element.

In another aspect of the invention the support element is operable between a first state configured to support the subject in a supine state, and a second state with the subject substantially inverted with the head of the subject depending downwardly from the torso of the subject and with the weight of the subject substantially supported by the shoulder engaging elements.

Preferably, the support element is operable between the first state and the second state through an angle greater than zero, and preferably, through an angle of at least 30°, and advantageously, through an angle of at least 45°, and more preferably through an angle of at least 60°, and ideally, through an angle of approximately 90°.

Preferably, the support element is pivotal between the first state and the second state about a main pivot axis extending substantially parallel to the shoulder axis defined by the shoulder accommodating recesses of the shoulder engaging elements.

Preferably, the main pivot axis about which the support element is pivotal between the first and second states extends relatively closely to the shoulder axis defined by the shoulder accommodating recesses.

In another aspect of the invention a ground engaging mounting element is provided, and the support element is coupled to the mounting element and is operable relative to the mounting element between the first and second states. Preferably, the support element is pivotally coupled to the mounting element about the main pivot axis.

In another aspect of the invention the mounting element is configured to support the support element in the first state with the support element at a height above the ground in the range of 500 mm to 900 mm. Preferably, the mounting element is configured to support the support element in the first state with the support element at a height above the ground in the range of 600 mm to 800 mm, and advantageously, the mounting element is configured to support the support element in the first state with the support element at a height above the ground of approximately 700 mm.

Advantageously, the support element is pivotally coupled to the mounting element by a main shaft defining the main pivot axis, and advantageously, the support element is rigidly coupled to the main shaft.

In one embodiment of the invention a drive means is provided for urging the support element between the first state and the second state.

In one aspect of the invention the drive means comprises a drive ram, which advantageously, comprises one of an hydraulic and a pneumatic ram. Preferably, the drive ram is configured to act between the support element and the mounting element.

In another aspect of the invention the drive means comprises a drive motor mounted on one of the mounting element and the support element, and a drive transmission means is provided for transmitting drive from the drive motor to the other one of the mounting element and the support element.

In another embodiment of the invention a control means is provided for controlling the operation of the drive means, and an interface means accessible to a subject on the support element is provided for inputting a signal to the control means for controlling operation of the drive means.

Preferably, the support element extends longitudinally between a head end and a foot end for receiving the subject with the head of the subject towards the head end, and the feet of the subject towards the foot end.

Preferably, a head end portion of the support element extending from the main pivot axis and the head end of the support element extends beyond the mounting element.

Advantageously, the support element comprises an elongated platform extending between the head end and the foot end thereof.

In another aspect of the invention a foot engageable element is located on the support element spaced apart longitudinally from the shoulder engaging elements and is moveable in a general direction longitudinally towards and away from the shoulder engaging elements, and a force applying means is co-operable with the foot engageable element for applying a force to the foot engageable element acting in a general direction longitudinally towards the shoulder engaging elements.

Preferably, the foot engageable element is configured to be engageable by at least one foot of the subject so that the foot engageable element is urgeable by the foot of the subject in the general direction longitudinally away from the shoulder engaging elements against the force applied thereto by the force applying means. Advantageously, the foot engageable element is configured to be engageable by the respective feet of the subject.

In one aspect of the invention a guide means mounted on the support element guides the foot engageable element in the general direction longitudinally towards and away from the shoulder engaging elements. Preferably, the foot engageable element is slideably mounted on the guide means and is slideable on the guide means in the general direction longitudinally towards and away from the shoulder engaging elements.

In one embodiment of the invention the force applying means is configured to apply the force to the foot engageable element when the support element is in the second state.

Preferably, the force applying means is adjustable for varying the force applied to the foot engageable element.

In one aspect of the invention the force applying means comprises a weight carrying element for selectively and releasably carrying one or more weights for providing the force to the foot engageable element. Alternatively, the force applying means comprises a resilient element acting between the foot engageable element and the support element. Preferably, the resilient element comprises one of a mechanical spring, a pneumatic spring and an hydraulic spring.

In one aspect of the invention a connecting member extends between the foot engageable element and the force applying means for connecting the foot engageable element to the force applying means.

In another aspect of the invention the force applying means is located beneath the support element, and a longitudinally extending elongated slot extends through the support element for accommodating the connecting member between the force applying means and the foot engageable element and to permit movement of the connecting element in the general direction longitudinally towards and away from the shoulder engaging elements.

In another aspect of the invention at least one handgrip configured to be gripped by one or both hands of the subject is connected to the force applying means, so that by one of pulling and pushing the at least one handgrip, the force applied by the force applying means is applied to the at least one handgrip for exercising muscles in the arm of the subject. Preferably, the at least one handgrip is connected to the force applying means by one of a flexible ligature and a rigid member. Advantageously, a pair of handgrips are provided.

In another aspect of the invention each handgrip is connected to the force applying means.

In one aspect of the invention the shoulder engaging elements are adjustably mounted on the support element. Preferably, the shoulder engaging elements are selectively moveable in a generally longitudinal direction relative to the support element.

The invention also provides a method for supporting a subject in a substantially inverted state, the method comprising providing apparatus comprising a support element having a pair of shoulder engaging elements located on the support element, the shoulder engaging elements being configured to support the subject in the substantially inverted state, and locating the subject on the support element with the subject substantially inverted on the support element, with the shoulder engaging elements engaging the respective shoulders of the subject and substantially bearing the weight of the subject.

Preferably, the subject is secured to the support element by a securing means. Advantageously, the subject is secured to the support element by the securing means engaging the torso of the subject.

Preferably, the support element is operable between a first state with the subject supported on the support element in a supine state, and a second state with the subject in the substantially inverted state with the head of the subject depending downwardly from the torso of the subject, and the subject is located on the support element with the support element in the first state prior to operating the support element from the first state to the second state.

Advantageously, the subject is secured to the support element with the support element in the first state and with the shoulders of the subject engaging the shoulder engaging elements.

In one embodiment of the invention the apparatus comprises apparatus according to the invention, and the support element comprises the support element of the apparatus.

Preferably, muscles in one of the legs of a subject on the support element are exercised by urging the foot engageable element by at least one foot of the subject against the force applied by the force applying means.

Advantageously, the muscles in an arm of a subject on the support element are exercised by one of pulling and pushing the at least one handgrip by one of the hands of the subject against the force applied by the applying means.

The advantages of the invention are many. By virtue of the fact that the subject when secured to the support platform in the second state, the subject is inverted with the head of the subject depending downwardly from the torso, oxygenation of the blood of the subject is considerably more efficient than when the subject is standing in a normal upright state. This is due to the fact that the alveoli, which when a subject is standing in a normal upstanding state are located at the lower ends of the lungs, and which air breathed into the lungs seldom reaches, when the subject is in the inverted state, are at the upper ends of the lungs, and thus receive more oxygen than they would when the subject is in a normal upright standing state. Thus, when a subject is in an inverted state, the efficiency of oxygenation of the blood is significantly increased. By increasing the oxygenation of the blood, a person can think more quickly and efficiently, and furthermore, oxygen is delivered to the muscles at a higher rate, thereby facilitating more efficient exercising of the muscles when the subject is in the inverted state.

Additionally, by virtue of the fact that the subject in the inverted state is supported by his or her shoulders engaging the shoulder engaging elements, the subject experiences no discomfort when in the inverted state over extended periods of time, which would otherwise be experienced if the subject were in the inverted state over extended periods of time as a result of headstands or handstands.

Thus, since a subject can remain in the inverted state without discomfort over extended periods of time, the efficiency of oxygenation of the blood over such extended periods of time can be significantly increased, thereby improving the neurological responses of the brain not only during the periods while the subject is in the inverted state, but for a significant length of time thereafter.

A further advantage of the invention is that it has been found that massaging the head and neck of the subject with the subject in the inverted state further invigorates the head and neck of the subject with fresh efficiently oxygenated blood. Having the subject inverted with the head depending downwardly from the torso significantly enhances the flow of fresh blood to the head and neck during such massaging. Additionally, with the body of the subject inverted, gravity acting on the body acts on the body in the opposite direction to the normal direction in which gravity acts on the body of a subject standing in a normal upright state, and it has been found that this provides innumerable health benefits to the subject and also enhances fitness of the individual together with tightening up of the abdomen muscles and substantially all other muscles. Massaging of the head and neck of a subject when the subject is inverted with the head of the subject depending downwardly also enhances beauty treatments being applied to the subject.

Additionally, it has been found that by supporting a subject in the inverted state on the apparatus according to the invention for extended periods of time provides the additional advantage that the effect of gravity acting on the body of the subject is reversed to the effect of gravity acting on the body of a subject standing in a normal upstanding state. In particular, this reversal of the effect of gravity on the body of a subject when in the inverted state has particular beneficial effects on the face, and in particular, on the jowls of the face, the buttocks and the abdomen of a subject and on the breasts of a female subject, in that the reversal of the effects of gravity acting on the body of a subject in the inverted state assists in toning of the face muscles, including the jowl muscles, the breast muscles, the buttocks muscles and the abdominal muscles for in turn lifting the jowls, breasts, buttocks and abdomen of a subject. Additionally, it has been found that inversion of a subject for extended periods of time also assists in the removal of facial and other wrinkles from the skin of the subject. Additionally, by inverting a subject for extended periods of time on the apparatus according to the invention, the gravitational effect on the organs of the subject is reversed, and the effect of gravity on fluids within cells, glands and organs of the body is also reversed, which it has been found has many beneficial effects on the subject. Furthermore, the inversion of a subject on the apparatus according to the invention also has many positive and beneficial effects on the mood, energy and relaxation of the subject, this, in general, is believed to be due to the enhanced oxygenation of the blood, and furthermore, the fact that with the subject inverted, blood can be more easily delivered to more remote parts of the body.

It has further been found that inversion of a subject on the apparatus according to the invention has significant beneficial effects on the lymphatic system of a human subject. The lymphatic system of a human subject includes a number of nodes and glands which include non-return valves for collecting poisonous toxic waste from the body, and draining such toxic waste from the body. It has been found that by inverting a subject on the apparatus according to the invention for extended periods of time provides an effective backwash for emptying the nodes and glands of the lymphatic system of such waste, as well as microbes which have set up residence in the lymphatic system and other remote locations, and which produce some of the most aggressive and detrimental scavenger cells which consume healthy probiotic bacteria in the body. This advantage is also relevant to the digestive system.

Accordingly, inversion of a subject for extended periods on the apparatus according to the invention has positive beneficial effects on the whole body, as well as the internal and external organs, the brain and the cardiovascular system of the body of a human subject.

The invention will be more clearly understood from the following description of some preferred embodiments thereof, which are given by way of example only, with reference to the accompanying drawings, in which:

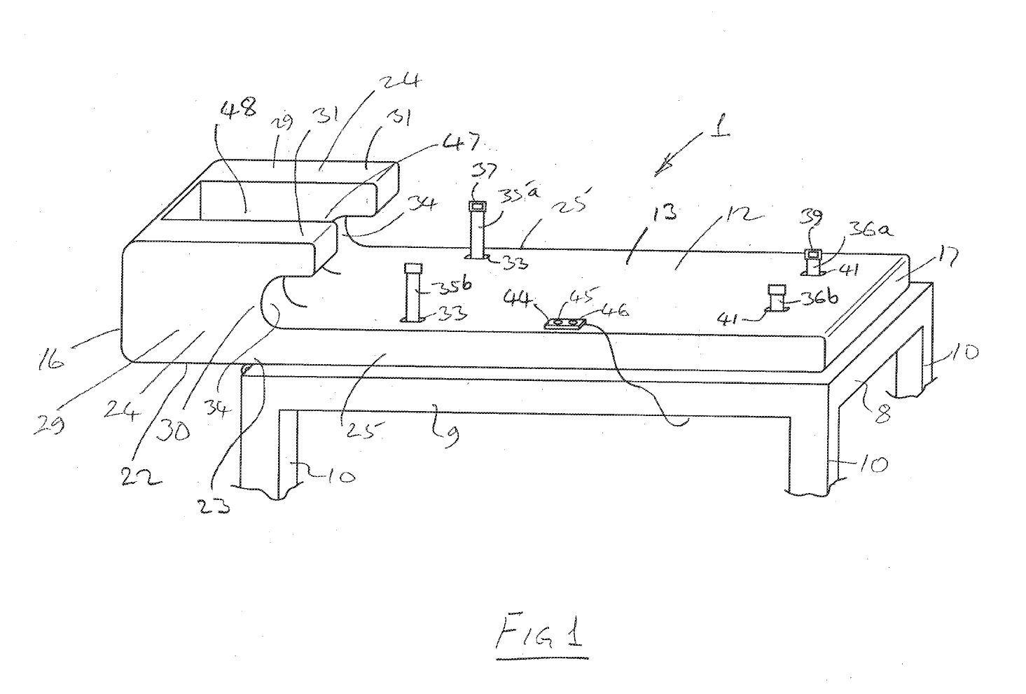

FIG. 1 is a perspective view of apparatus according to the invention for supporting a subject in an inverted state,

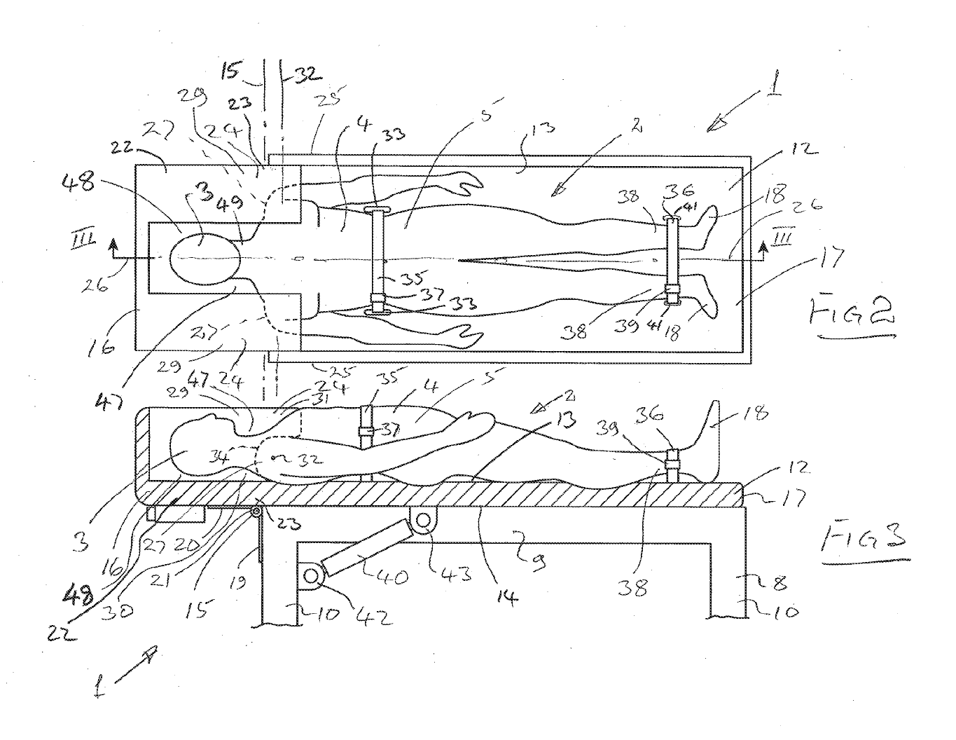

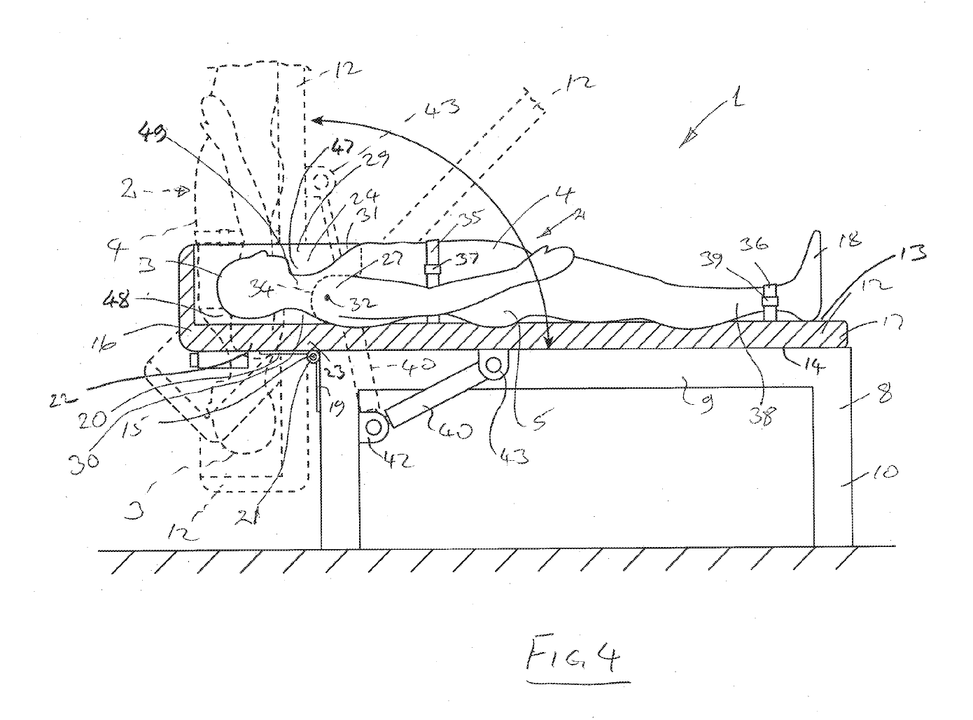

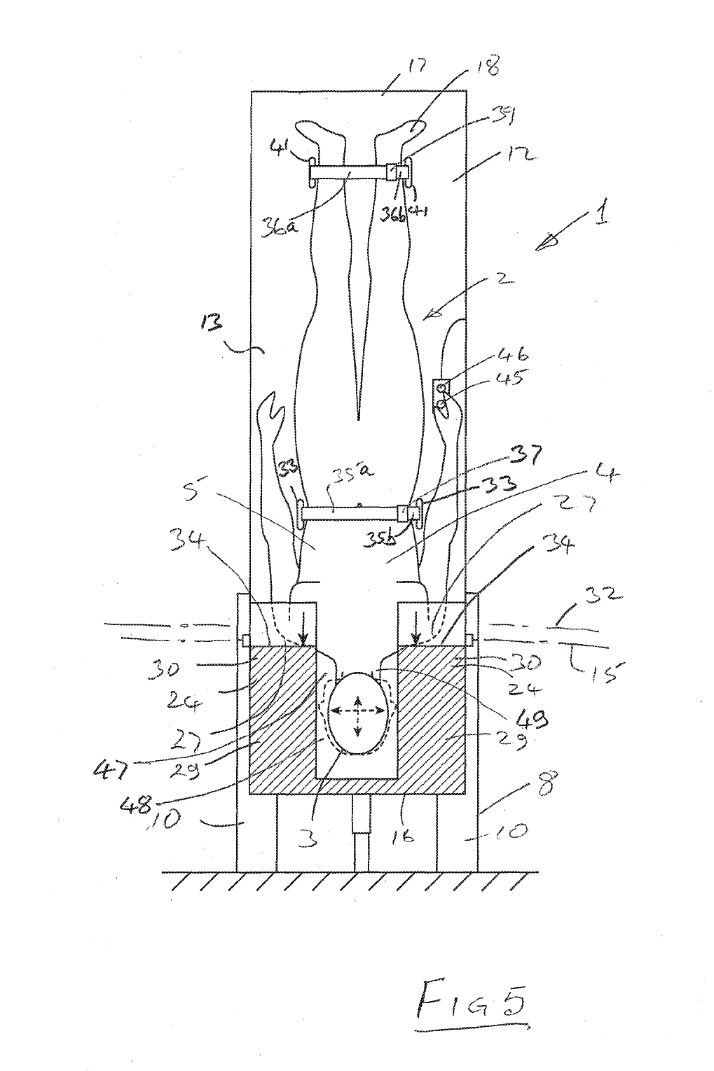

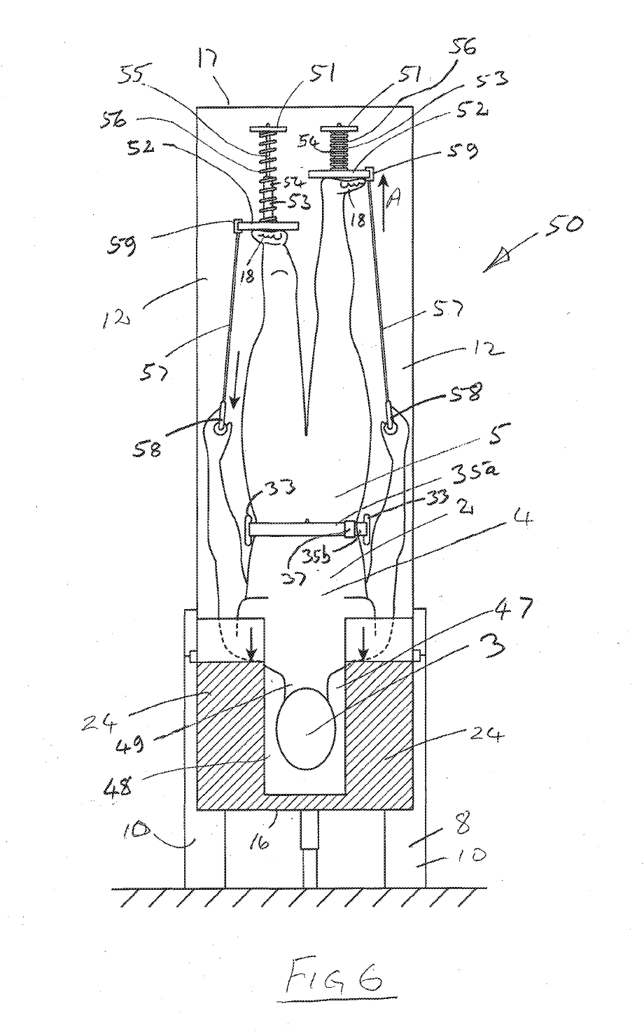

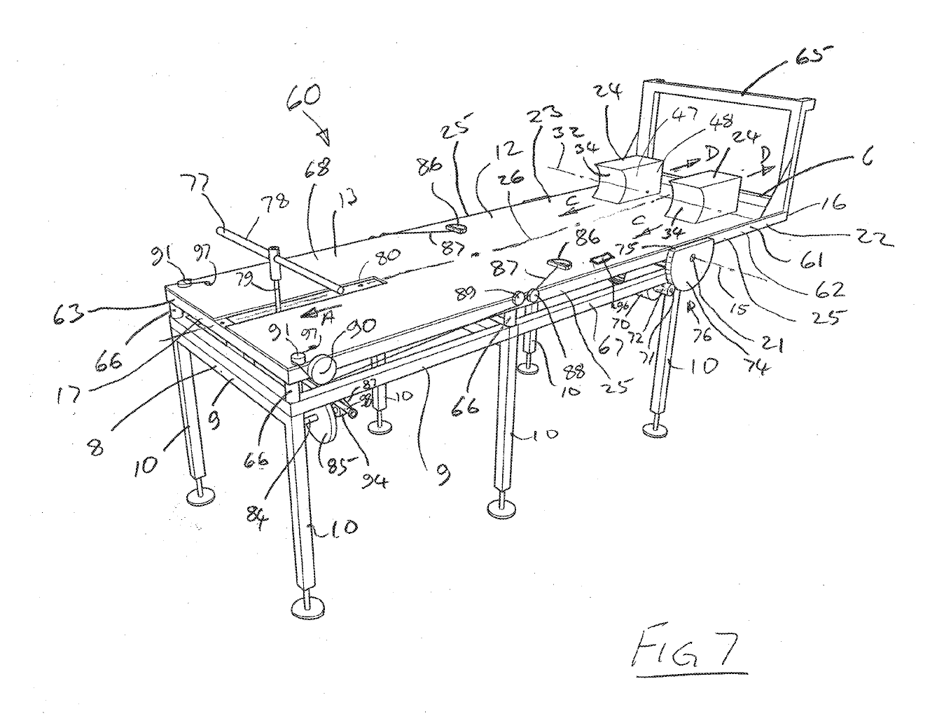

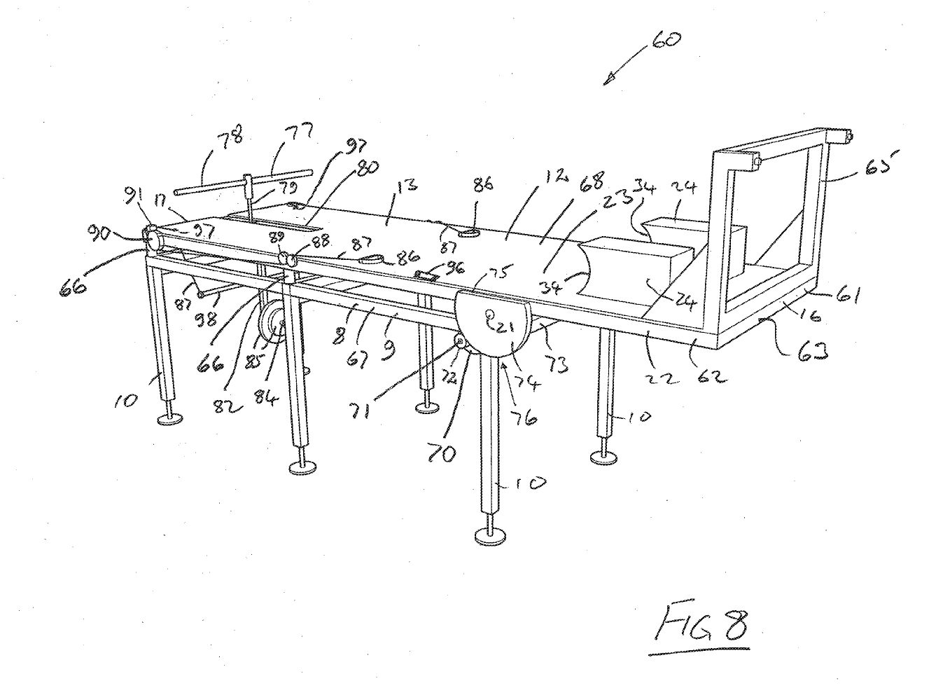

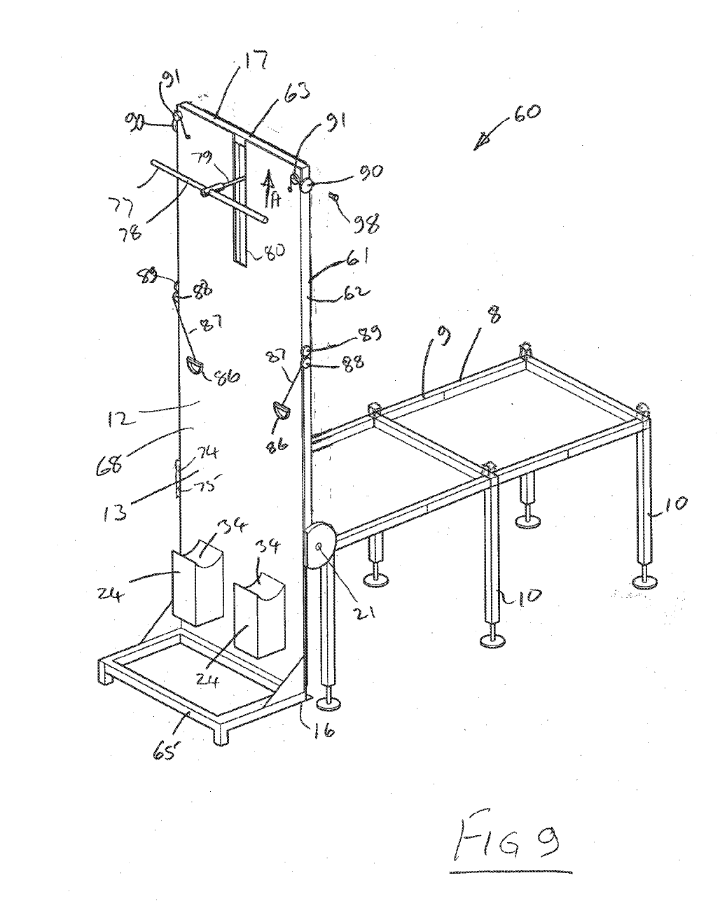

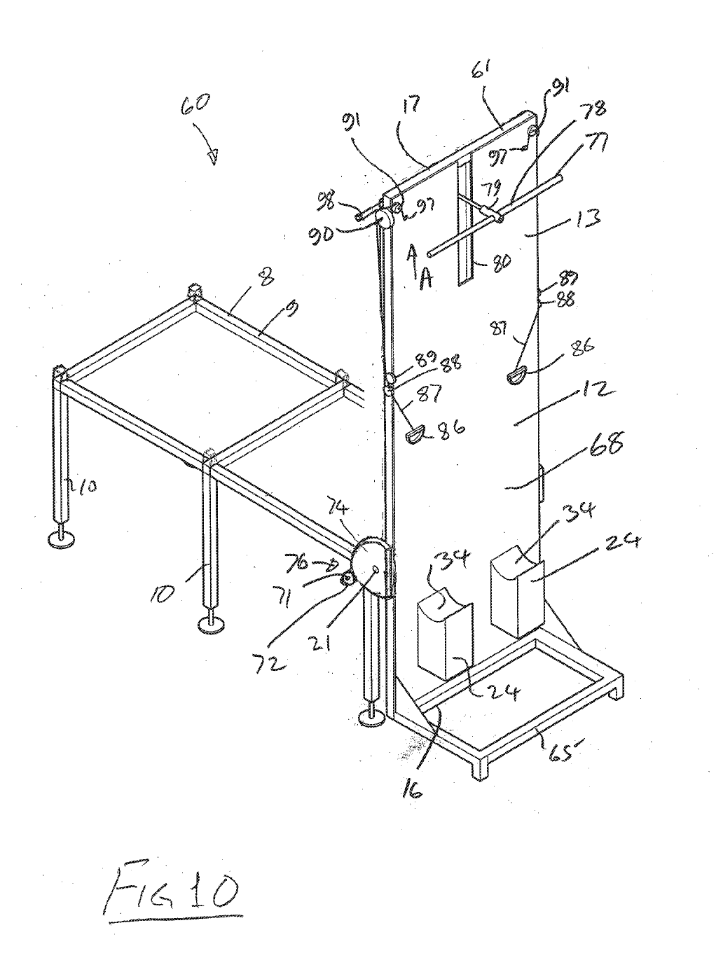

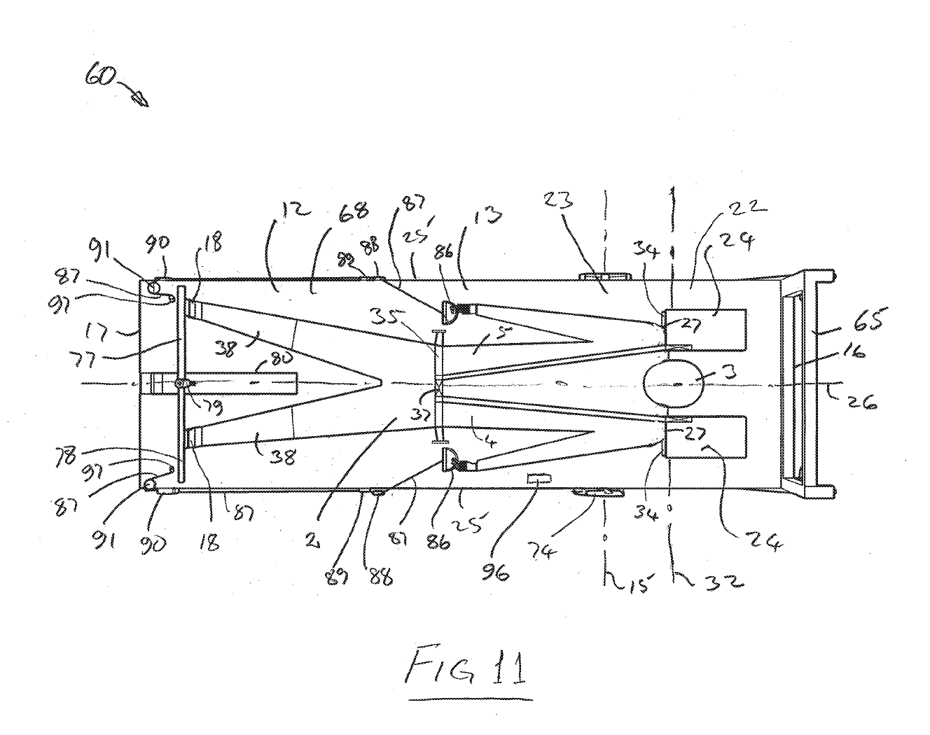

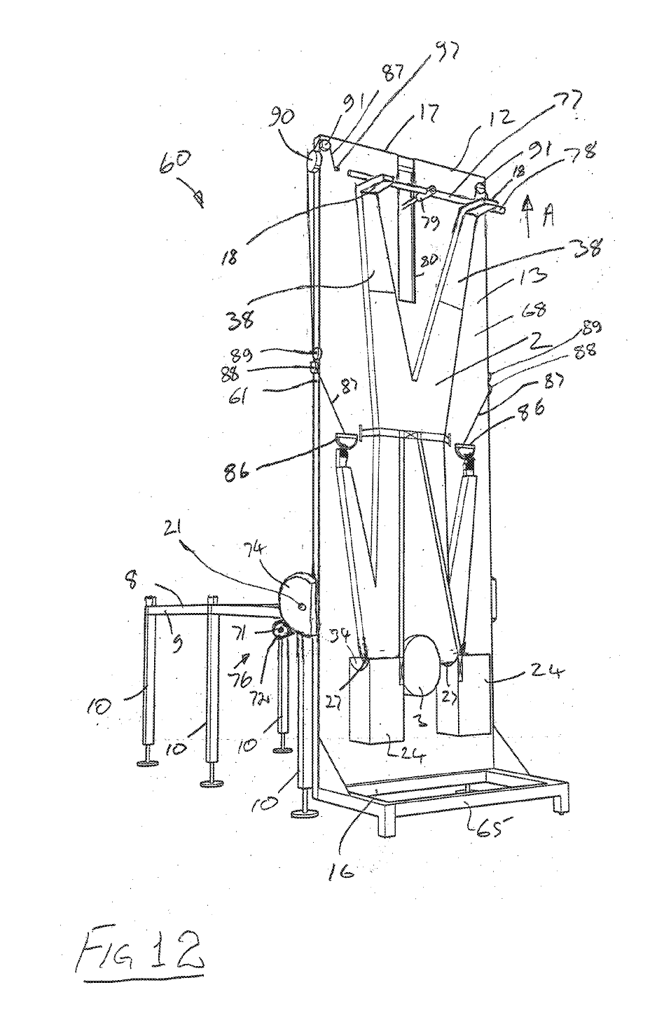

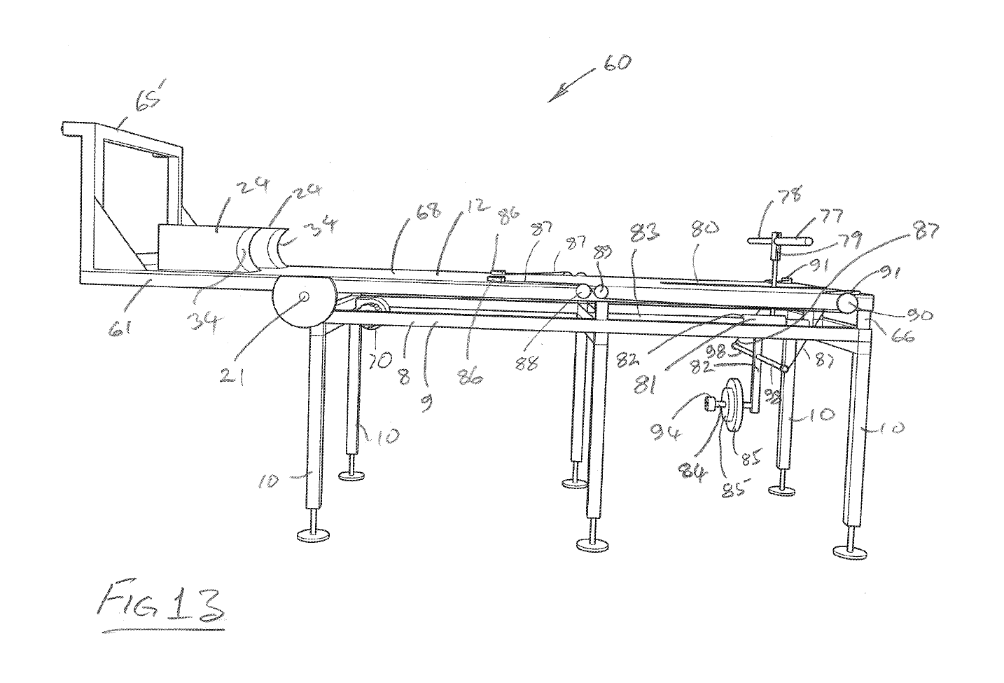

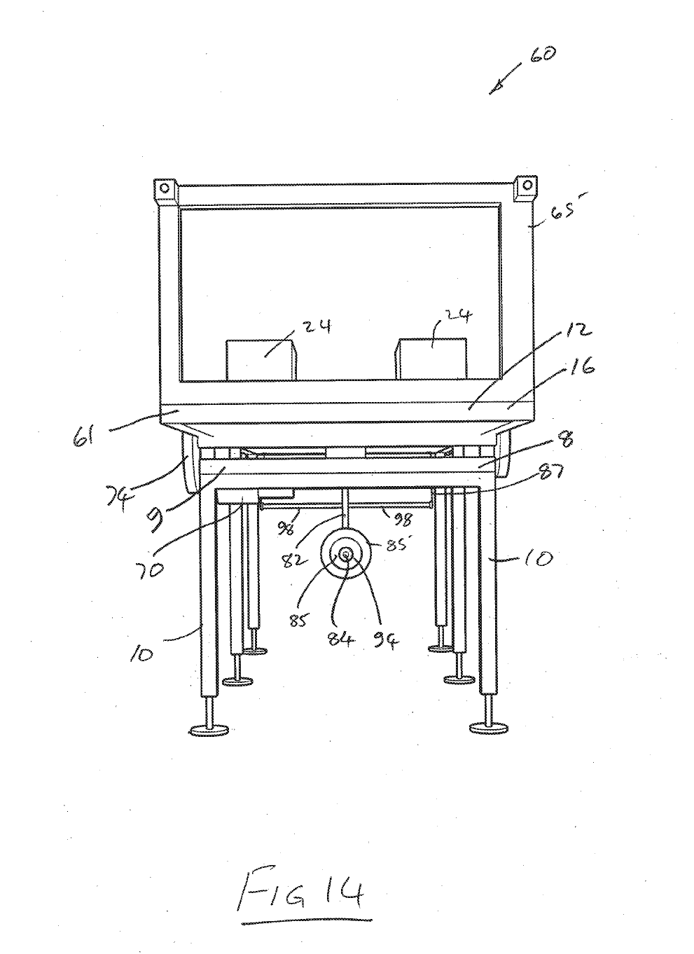

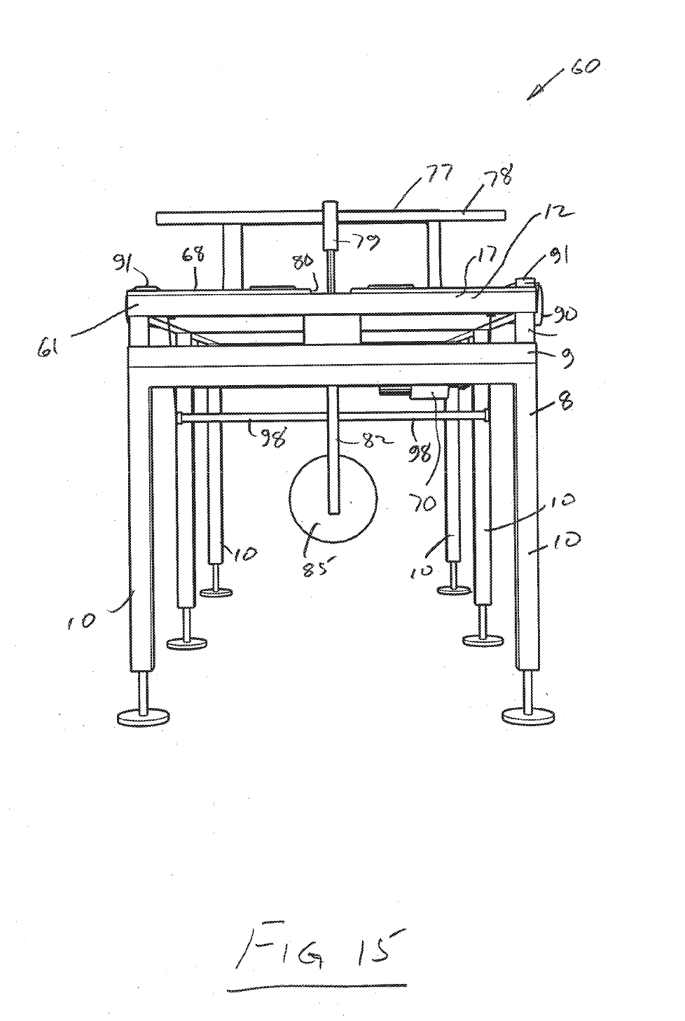

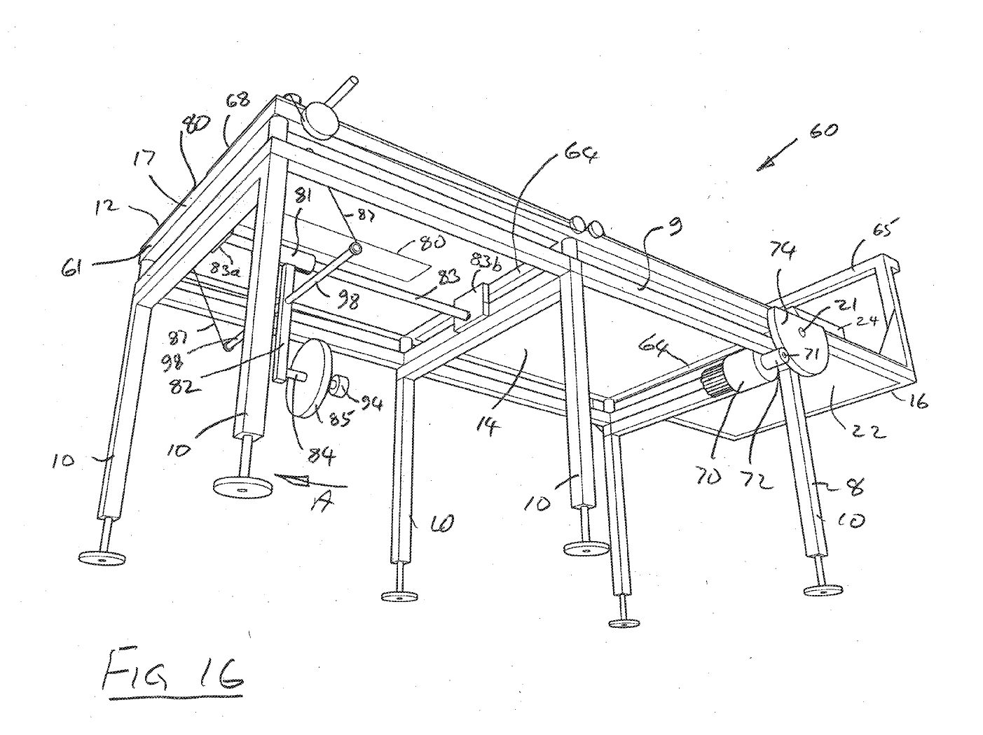

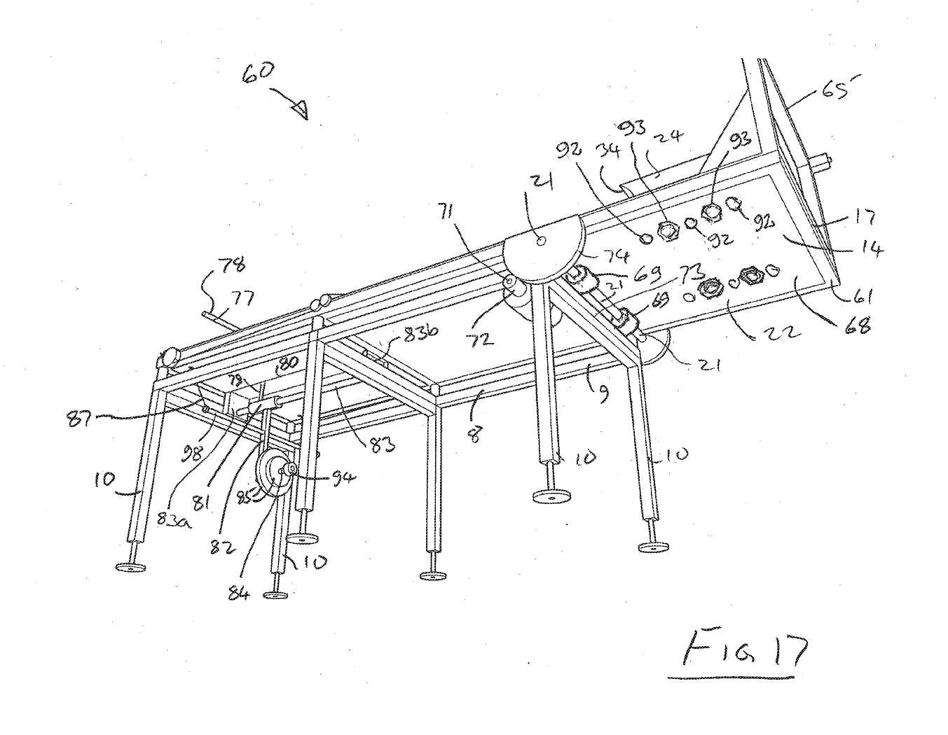

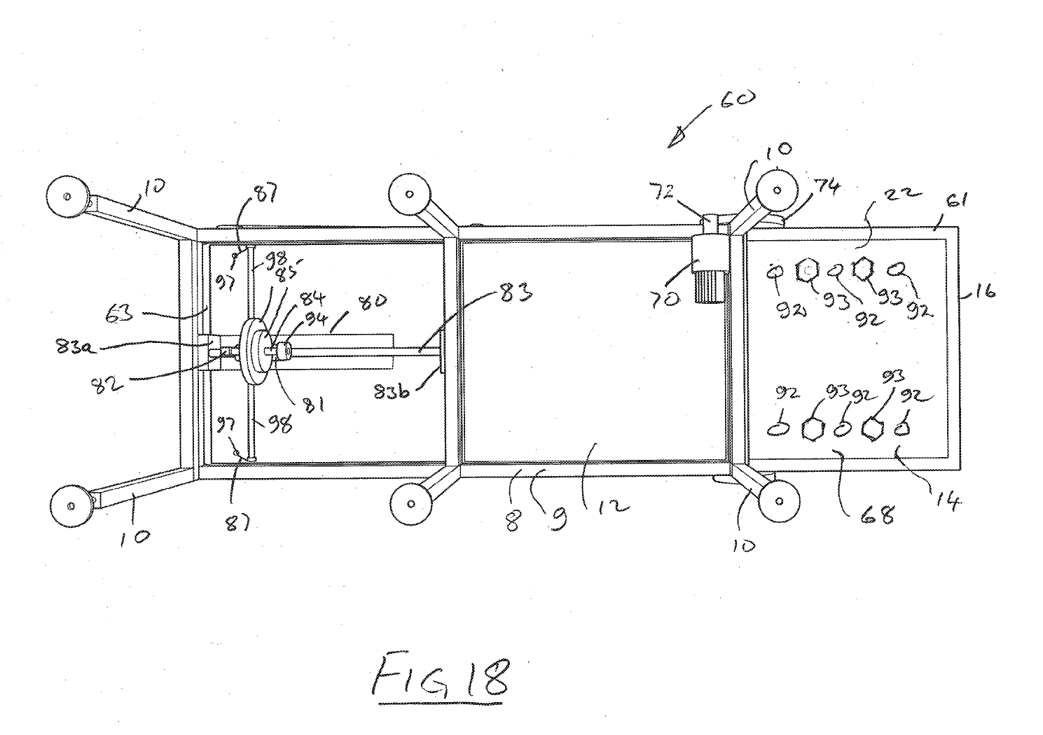

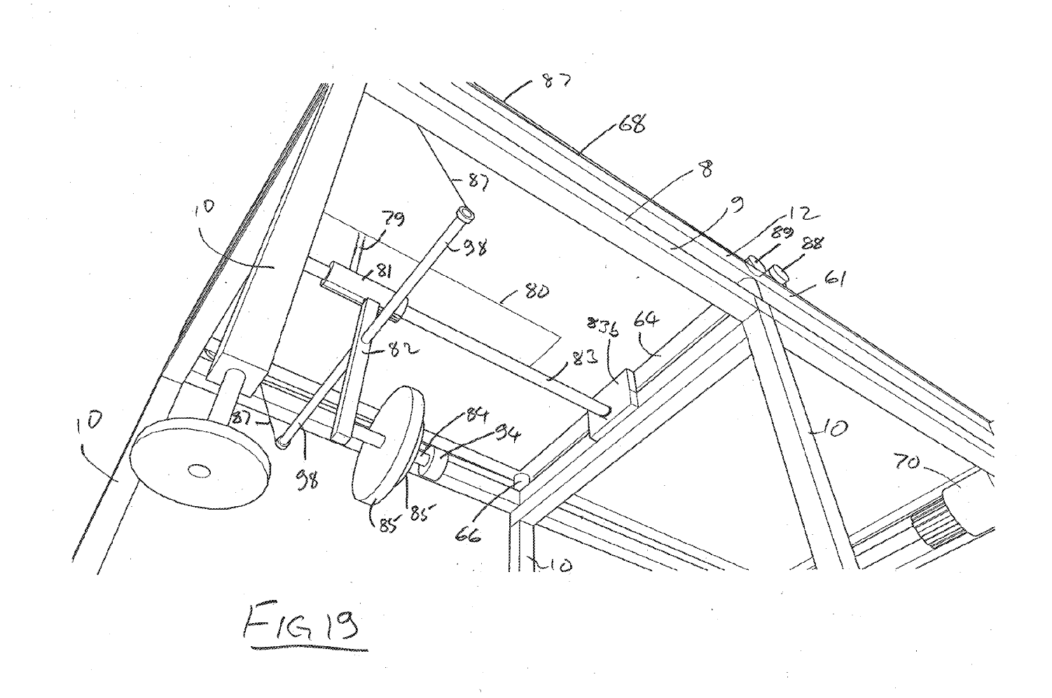

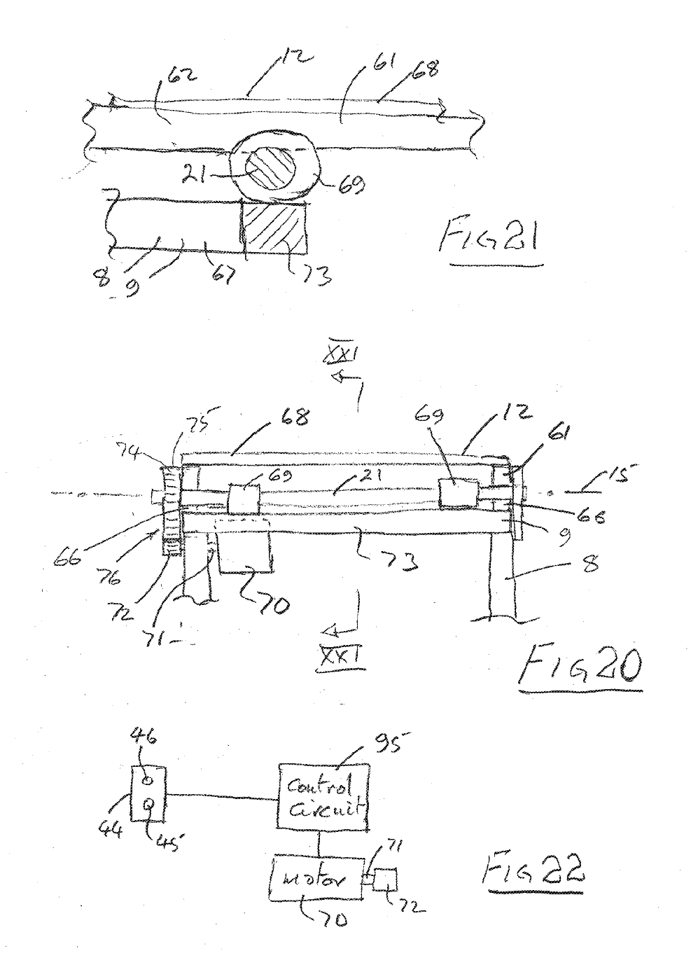

FIG. 2 is a top plan view of the apparatus of FIG. 1 in use,

FIG. 3 is a transverse cross-sectional side elevational view of the apparatus of FIG. 1 in use on the line III-III of FIG. 2,

FIG. 4 is a view similar to FIG. 3 illustrating the apparatus of FIG. 1 in use,

FIG. 5 is an end elevational view of the apparatus of FIG. 1 in a different state to that of FIG. 3,

FIG. 6 is a perspective view of apparatus according to another embodiment of the invention for supporting a subject in an inverted state,

FIG. 7 is a perspective view of apparatus according to another embodiment of the invention for supporting a subject in an inverted state,

FIG. 8 is another perspective view of the apparatus of FIG. 7,

FIG. 9 is a perspective view of the apparatus of FIG. 7 in a different state to that of FIG. 7,

FIG. 10 is another perspective view of the apparatus of FIG. 7 in the state of FIG. 9,

FIG. 11 is a top plan view of the apparatus of FIG. 7 in the state of FIG. 7 in use,

FIG. 12 is a perspective view of the apparatus of FIG. 7 in the state of FIG. 9 in use,

FIG. 13 is another perspective view of the apparatus of FIG. 7,

FIG. 14 is a perspective view of the apparatus of FIG. 7 from the head end thereof,

FIG. 15 is a perspective view of the apparatus of FIG. 7 from a foot end of the apparatus,

FIG. 16 is an underneath perspective view of the apparatus of FIG. 7,

FIG. 17 is another underneath perspective view of the apparatus of FIG. 7,

FIG. 18 is an underneath plan view of the apparatus of FIG. 7,

FIG. 19 is a perspective view of a detail of the apparatus of FIG. 7,

FIG. 20 is an end elevational view of a detail of the apparatus of FIG. 7,

FIG. 21 is a cross-sectional side elevational view of the detail of the apparatus of FIG. 20 on the line XXI-XXI of FIG. 20, and

FIG. 22 is a block representation of an electrical circuit diagram of the apparatus of FIG. 7.

Referring to the drawings and initially to FIGS. 1 to 5, there is illustrated apparatus according to the invention, indicated generally by the reference numeral 1, for supporting a subject 2, in this embodiment of the invention a human subject, in a substantially inverted state with the head 3 of the subject depending downwardly from the torso 4 of the body 5 thereof. The apparatus 1 comprises a mounting element, namely, a ground engaging plinth 8 having an upper framework 9 and four downwardly extending ground engaging means, namely, ground engaging legs 10.

A support element, in this embodiment of the invention an elongated support platform 12 having a top surface 13 and an underneath surface 14 extends between a head end 16 and a foot end 17 for supporting the subject 2 on the top surface 13 thereof with the head 3 of the subject 2 towards the head end 16 and feet 18 of the subject towards the foot end 17 of the support platform 12. The support platform 12 is pivotally coupled to the upper framework 9 of the plinth 8 about a main pivot axis 15, which extends transversely of the support platform 12. A pair of pivot mounting brackets 19 and 20 secured to the plinth 8 and the support platform 12, respectively, pivotally carry a main pivot shaft 21 which defines the main pivot axis 15 about which the support platform 12 is pivotal. The support platform 12 is pivotal about the main pivot axis 15 through an angle of approximately 90° from a first state illustrated in FIGS. 1 to 4 with the support platform 15 extending substantially horizontally and resting on the plinth 8 with the subject 2 lying in a supine state, and a second state illustrated in FIG. 5 with the support platform 12 extending substantially vertically with the subject 2 inverted and with the head 3 of the subject 2 depending generally downwardly from the torso 4 of the subject. A head end portion 22 of the support platform 12 extending from a location 23 adjacent the main pivot axis 15 to the head end 16 extends beyond the plinth 8 when the support platform 12 is in the first state in order to facilitate pivoting of the support platform 12 between the first state and the second state.

A pair of spaced apart shoulder engaging elements 24 are mounted adjacent respective opposite sides 25 of the support platform 12 spaced apart on respective opposite sides of a main centre line 26 extending centrally along the support platform 12 for engaging and supporting the shoulders 27 of the subject 2 when the support platform 12 is in the second state with the subject 2 inverted. In this embodiment of the invention each shoulder engaging element 24 comprises an L-shaped element 29 comprising a first leg 30 extending from the platform 12, and a second leg 31 extending from the first leg 30 spaced apart from and parallel to the support platform 12. The first leg 30 and the second leg 31 of each shoulder engaging element 24 define with the top surface 13 of the support platform 12 a shoulder accommodating recess 34 for engaging the corresponding shoulder 27 of the subject 2 with the shoulder embraced by a combination of the shoulder engaging element 24 and the support platform 12. In this way the shoulder engaging elements 24 engage and retain the shoulders 27 of the subject 2 on the support platform 12 and bear the weight of the subject 2 when the support platform 12 is in the second state.

The shoulder accommodating recesses 34 of the shoulder engaging elements 24 define a common shoulder axis 32 which extends transversely of the support platform 12 and parallel to the main pivot axis 15. Additionally, the shoulder axis 32 defined by the shoulder accommodating recesses 34 extend substantially parallel to a transverse line joining the shoulders 27 of the subject. In this embodiment of the invention the shoulder engaging elements 24 are located on the support platform 12 so that the shoulder axis 32 defined by the shoulder accommodating recesses 34 is located relatively closely to the main pivot axis 15, and the main pivot shaft 21 is coupled to the plinth 8 and the support platform 12 with the main pivot axis 15 lying substantially almost directly below the shoulder axis 32 defined by the shoulder accommodating recess 34 when the support platform 12 is in the first state.

A securing means which comprise a torso securing means, namely, a torso strap 35 and leg securing means, namely, a leg strap 36 are provided for securing the torso 4 and the legs 38 of the subject to the support platform 12. The torso strap 35 comprises a first part 35a and a second part 35b, both of which are anchored to the support platform 12 on the underneath surface 14, and extend through the openings 33 in the support platform 12. A buckle 37 secured to the end of the first part 35a of the torso strap 35 engages the second part 35b of the torso strap 35 for securing the torso strap 35 across the torso 4 of the subject 2 adjacent the waist thereof, for in turn securing the torso 4 of the subject 2 to the support platform 12. The leg strap 36 comprises a first part 36a and a second part 36b, both of which are anchored to the support platform 12 on the underneath surface 14, and extend through corresponding openings 41 in the support platform 12. A buckle 39 secured to the end of the first part 36a of the leg strap 36 engages the second part 36b of the leg strap 36 for securing the leg strap 36 across the legs 38 of the subject 2, so that the legs 38 of the subject 2 are secured to the support platform 12.

A drive means for urging the support platform 12 between the first state and the second state in this embodiment of the invention comprises a drive ram 40, which may be hydraulically or pneumatically operated and typically, would be pneumatically operated. The drive ram 40 is coupled between the plinth 8 and the support platform 12 by pivot mounting brackets 42 and 43 secured to the plinth 8 and the support platform 12, respectively. A control means comprising a control circuit (not shown) is provided for controlling operation of the drive ram 40 for urging the platform 12 between the first state and the second state.

A handheld control element 44 is wired to the control circuit (not shown), and comprises first and second control button switches 45 and 46, respectively, for controlling the control circuit to operate the drive ram 40 for urging the support platform 12 from the first state to the second state, and from the second state to the first state, respectively. The control element 44 is releasably retained on the support platform 12 at a convenient location by a magnet (not shown) in the support platform 12, to be readily accessible to one of the hands of the subject 2, so that the subject 2 can operate the support platform 12 between the first and second states.

As discussed above, the shoulder engaging elements 24 are spaced apart from each other, and in this embodiment of the invention define both a neck accommodating space 47 and a head accommodating space 48 for accommodating the neck 49 and the head 3 of the subject 2 therebetween. The spacing between the shoulder engaging elements 24 is such as to permit free side to side movement of the head and neck of the subject 2 and to facilitate massaging of the head and neck of the subject 2.

In use, with the plinth 8 mounted on the ground and the ground engaging legs 10 secured to the ground by suitable fixing elements, for example, masonry screws or bolts, and with the support platform 12 in the first state, a subject lies in a supine state on the platform 12 with the shoulders 27 of the subject 2 engaged in the shoulder accommodating recesses 34 of the corresponding shoulder engaging elements 24. The torso 4 and the legs 38 of the subject 2 are secured to the support platform 12 by the torso and leg straps 35 and 36. When the subject is ready to be inverted, the subject depresses the first control button switch 45 of the handheld control element 44, which in turn operates the drive ram 40 to pivot the support platform 12 from the first state to the second state with the subject 2 inverted and supported on the support platform 12 by the shoulder engaging elements 24 and with the head 3 of the subject 2 depending downwardly from the torso 4.

Massaging of the head and neck of the subject can then be carried out, and beauty treatments may also be applied to the face of the subject. The subject may also exercise his or her abdominal muscles while in the inverted state. Additionally, while the subject is in the inverted state, the blood of the subject is oxygenated efficiently due to the fact that the alveoli adjacent the lower ends of the lungs, which with the subject 2 inverted become the top ends of the lungs, receive significantly more oxygen during breathing of the subject 2 in the inverted state.

On completion of the treatments of the subject in the inverted state, or when the subject wishes to operate the support platform 12 to the first state, the subject 12 depresses the second control button switch 46 of the handheld control element 44, which in turn controls the control circuit (not shown) to operate the drive ram 40 for pivoting the support platform 12 from the second state to the first state. When the support platform 12 has been returned to the first state, the torso and leg straps 35 and 36 are released, and the subject can dismount from the support platform 12.

Referring now to FIG. 6, apparatus according to another embodiment of the invention, indicated generally by the reference numeral 50, is illustrated. The apparatus 50 is substantially similar to the apparatus 1, and similar components are identified by the same reference numerals. In FIG. 6, the apparatus is illustrated in use with the support platform 12 in the second state, and is particularly suitable for permitting a subject 2 in the inverted state to carry out leg and arm exercises, as well as working out the abdominal muscles.

In this embodiment of the invention a pair of anchor elements, namely, a pair of anchor brackets 51 are rigidly secured to the support platform 12 adjacent the foot end 17 thereof. A pair of foot engageable elements 52 are coupled to the respective anchor brackets 51 by corresponding guide means, namely, guide elements 53, each of which comprise a pair of telescoping members, namely, an outer telescoping member 54 and an inner telescoping member 55 which is slideable within the outer telescoping member 54. The inner telescoping member 55 of each guide element 53 is secured to the corresponding anchor bracket 51, while the outer telescoping member 54 is secured to the corresponding foot engageable element 52. The guide elements 53 guide the foot engaging elements 53 in a general direction longitudinally and substantially parallel to the main centre line 26 towards and away from the corresponding shoulder engaging elements 24.

A force applying means, in this embodiment of the invention a pair of resilient elements, namely, a pair of compression springs 56 acting between the corresponding anchor brackets 51 and the foot engageable elements 52 apply a force to the foot engageable elements 52 in the general direction longitudinally and substantially parallel to the main centre line 26 towards the corresponding shoulder engaging element 24. The force applied to the foot engageable elements 52 by the compression springs 56 urge the foot engageable elements 52 in the general direction longitudinally towards the shoulder engaging elements 24 to the extremity of the travel of the foot engageable elements 52, which is constrained by the outer and inner telescoping members 54 and 55. Accordingly, a subject 2 secured to the support platform 12 by the torso strap 35, with his or her feet engaging the foot engageable elements 52, by urging the foot engageable elements 52 in the direction of the arrow A against the action of the compression springs 56 may carry out leg exercises to exercise the leg and abdominal muscles with the support platform 12 in the inverted state.

Arm exercising elements, namely, elongated rigid rods 57 extending between respective handgrips 58 and engagement brackets 59 are provided for exercising arm muscles of the subject 2. The engagement brackets 59 of the rods 57 are configured to releasably engage the corresponding foot engageable elements 52, so that with the engagement brackets 59 engaged with the corresponding foot engageable elements 52, by gripping the handgrips 58 of the respective rods 57, a subject 2 can exercise his or her arm muscles against the spring urging of the compression springs 56 against the foot engageable elements 52 by urging the foot engageable elements 52 in the direction of the arrow A by the rods 57. The arm muscles of the subject 2 may be exercised simultaneously with exercising the leg muscles, or independently of exercising the leg muscles by relaxing the feet on the foot engageable elements 52 or removing the feet from the foot engageable elements 52.

In use, with the subject 2 supported on the support platform 12 of the apparatus 50 and secured to the support platform 12, by the torso strap 35, the support platform 12 is pivoted about the main pivot axis 15 from the first state to the second state with the subject 2 inverted. The subject 2 by engaging the foot engageable elements 52 with his or her feet and urging the foot engageable elements 52 in the direction of the arrow A towards the anchor brackets 51 against the resilient urging of the compression springs 56 exercises leg muscles while in the inverted state. By attaching the rods 57 to the foot engageable elements 52 by the engagement brackets 59 and gripping the handgrips 58 of the rods 57, a subject 2 by urging the foot engageable elements 52 in the direction of the arrow A towards the anchor brackets 51 by the rods 57 against the resilient urging of the compression springs 56 exercises arm muscles. The arm muscles of the subject 2 may be exercised simultaneously with the exercising of the leg muscles, or the leg and arm muscles may be exercised independently of each other.

Additionally, while in the inverted state on the support platform 12 of the apparatus 50, the abdominal and hip muscles of the subject may also be exercised during exercising of the leg muscles with the foot engageable elements 52. Furthermore, the shoulder, back and chest muscles of the subject may also be exercised during exercising of the arm muscles with the rods 57 engaged with the foot engageable element 52. Accordingly, the apparatus 50 permits exercising of the biceps and triceps in conjunction with the chest, shoulder and back lateral muscles during a workout by the subject in the inverted state secured to the platform 12 in the second state by the torso strap 35. These parts use the legs from the hips to the thighs, calves by bending at the knees upwards and downwards motion to create the force that is required to activate the muscles in the various movements of the arms and vice versa. Indeed, it has been found that during a workout on the apparatus 50, a subject supported in the inverted state on the support platform 12 may exercise many muscles in his or her body. By using the rods 57 engaged with the foot engageable elements 52, the body only uses its own maximum strength to perform, thus leading to a reduced susceptibility to injury.

Referring now to FIGS. 7 to 21, there is illustrated apparatus according to another embodiment of the invention, indicated generally by the reference numeral 60, for supporting a subject 2 in an inverted state. The apparatus 60 is substantially similar to the apparatus 1, and similar components are identified by the same reference numerals. In this embodiment of the invention the support platform 12 comprises a support framework 61 formed by a pair of spaced apart longitudinally extending parallel side members 62 extending along the respective sides 25 of the support platform 12. The side members 62 are joined at the head end 16 and the foot end 17 of the support platform 12 by spaced apart parallel end members 63, and intermediate cross-members 64 extend transversely between the side members 62 at locations intermediate the end members 63. A head frame 65 extends upwardly from the end member 63 adjacent the head end 16 of the support platform 12. In this embodiment of the invention the support framework 61 and the head frame 65 are of box section steel material. A support base 68 is rigidly secured to and carried on the support framework 61 for supporting the subject 2 on the support platform 12. The support base 68 is of sheet timber material, but may be of any other suitable rigid or semi-rigid sheet material. The main pivot shaft 21 in this embodiment of the invention is rigidly secured to the support framework 61 by welding the main pivot shaft 21 to the side members 62.

In this embodiment of the invention the plinth 8 is also of box section steel, and short upstands 66 extend upwardly from respective opposite side members 67 of the upper framework 9 of the plinth 8 for abutting the side members 62 of the support framework 61, for supporting the support platform 12 in the first state. A pair of bearings 69 are mounted on an end cross-member 73 of the upper framework 9 of the plinth 8 and rotatably carry the main pivot shaft 21 for pivoting the support platform 12 relative to the plinth 8 about the main pivot axis 15 between the first and second states.

A drive means, in this embodiment of the invention comprising an electrically powered drive motor 70 is mounted on the upper frame 9 of the plinth 8 for pivoting the support platform 12 between the first state and the second state through a drive transmission 76. The drive transmission 76 comprises a pinion gear 72 mounted fast on a drive shaft 71 extending from the drive motor 70. The pinion gear 72 is in meshing engagement with a gearwheel 74 which is mounted fast on the main pivot shaft 21, so that drive is transmitted from the drive motor 70 through the pinion gear 72 and the gearwheel 74 to the main pivot shaft 21, for in turn pivoting the support platform 12 between the first and second states. In this embodiment of the invention a portion of the gearwheel 74 at 75 is removed, since only 90° of the gearwheel 74 is required to be engageable with the pinion gear 72 as the pinion gear 72 drives the gearwheel 74 for in turn pivoting the support platform 12 through 90° between the first and second states.

In this embodiment of the invention only a single foot engageable element 77 is provided, and the foot engageable element 77 is provided by a transversely extending foot engageable bar 78, which is engageable by both feet of the subject. The foot engageable bar 78 is carried on a connecting member 79 extending upwardly through an elongated longitudinally extending slot 80 in the support base 68 of the support platform 12 from a carrier element 81. The carrier element 81 comprises a linear bearing (not shown) located in the carrier element 81, which is slideably carried on a guide means, namely, a guide bar 83 which extends parallel to the side members 62 of the support framework 61 of the support platform 12 from the end member 63 of the framework 61 adjacent the foot end 17 thereof to the intermediate cross-member 64 of the support framework 61, which is closest to the foot end 17 of the support platform 12. In this embodiment of the invention the guide bar 83 is welded to mounting plates 83a and 83b, which in turn are welded to the end member 63 which is adjacent the foot end 17 of the support platform 12 and to the intermediate cross-member 64, respectively, and the guide bar 83 is located directly beneath the elongated slot 80 in the support base 68. The elongated slot 80 extends through the support base 68 from the foot end 17 of the support platform 12 to a location intermediate the foot end 17 and the intermediate cross-member 64 which is closest to the foot end 17 of the support platform 12, terminating relatively closely to that intermediate cross-member 64.

The carrier element 81 in this embodiment of the invention carries the force applying means, which in this case comprises a weight carrying means, namely, a longitudinally extending weight carrying bar 84 which is configured for releasably carrying selectable weights 85 of different weight values for applying a force to the foot engageable bar 78, which acts to urge the foot engageable bar 78 in a general direction longitudinally and parallel to the main centre line 26 of the support platform 12 towards the shoulder engaging elements 24. A downwardly connecting member 82 extends downwardly from the carrier element 81 and carries the weight carrying bar 84. A quick release securing element 94 is releasably engageable with the weight carrying bar 84 for retaining the weights 85 on the weight carrying bar 84. By virtue of the fact that selected weights 85 can be releasably engaged on the weight carrying bar 84, the force applied to the foot engageable element 77, when the support platform 12 is in the second state, in this embodiment of the invention is adjustable by merely removing or adding weights 85 to the weight carrying bar 84. The weights 85 may be added or removed from the weight carrying bar 84 when the support platform 12 is in either the first state or the second state, but preferably, when the support platform 12 is in the first state.

In this embodiment of the invention the foot engageable element 77, the carrier element 81, the guide bar 83, the connecting members 79 and 82 and weight carrying bar 84 are of steel welded together.

Handgrips 86 are connected through ligatures to the weight carrying bar 84, so that a subject 2 secured to the support platform 12 can exercise his or her arm muscles by gripping the handgrips 86 and pulling the handgrips 86, for in turn pulling the weight carrying bar 84 upwardly in the direction of the arrow A when the support platform 12 is in the second state. In this embodiment of the invention the ligatures comprise steel cables 87 which extend from the handgrips 86 around respective pairs of pulleys 88 and 89 on respective opposite sides 25 of the support platform 12. The steel cables 87 then pass around pulleys 90 adjacent the opposite corners of the support platform 12 adjacent the foot end 17, and in turn around pulleys 91 which are carried on the support base 68 adjacent the foot end 17 of the support platform 12. The pulleys 91 direct the steel cables 87 through openings 97 extending through the support base 68, and the steel cables 87 are secured to mounting members 98 extending transversely from the downwardly extending connecting member 82 on opposite sides thereof, for in turn connecting the handgrips 86 to the weight carrying bar 84.

In this embodiment of the invention the shoulder engaging elements 24 are adjustably mounted on the support platform 12 and are adjustable in the longitudinal directions of the arrows C and D to accommodate subjects of different heights. A plurality of spaced apart bores 92 extending through the support base 68 of the support platform 12 accommodate screws 93 for securing the shoulder engaging elements 24 at selectable desired locations on the support platform 12. Additionally, in this embodiment of the invention the shoulder accommodating recesses 34 are of arcuate shape formed into the shoulder engaging elements 24.

Referring now to FIG. 22, a control circuit 95 is provided for controlling the operation and the direction of drive of the drive motor 70. The handheld control element 44 is wired to the control circuit 95. Depressing the first control button switch 45 of the handheld control element 44 activates the control circuit 95 to operate the drive motor 70 for pivoting the support platform 12 from the first state to the second state. Depressing the second control button switch 46 of the handheld control element 44 activates the control circuit 95 to operate the drive motor 70 for pivoting the support platform 12 from the second state to the first state. A magnet 96 is located on the support platform 12 adjacent one side 25 thereof at a convenient location to retain the handheld control element 44 to be easily accessible to the subject 2 secured to the support platform 12, when the support platform 12 is in both the first and second states, so that the subject can readily operate the support platform 12 between the first and second states.

Otherwise, the apparatus 60 is substantially similar to the apparatus 1.

In use, the shoulder engaging elements 24 are located in the desired location on the support platform 12 and are secured thereto by the screws 93 through selected ones of the bores 92. The appropriate number and magnitudes of the weights 85 are mounted on the weight carrying bar 84 and are secured thereto by the quick release securing element 94 in order to provide the desired force which is to be applied to the foot engageable element 77. With the shoulder engaging elements 24 located in the desired location, and the appropriate number of weights 85 of the desired magnitudes secured to the weight carrying bar 84, the apparatus 60 is ready for use.

With the support platform 12 in the first state, a subject 2 lies on the platform in a supine state with the shoulders 27 of the subject engaging the shoulder accommodating recesses 34 of the shoulder engaging elements 24. The torso strap 35 is secured across the torso 4 of the subject 2 adjacent the waist of the subject. With the foot engageable element 77 located adjacent the end of the slot 80 adjacent the intermediate cross-member 64, the subject extends his or her legs beneath the foot engageable element 77. The drive motor 70 is activated by depressing the first control button switch 45 of the handheld control element 44 for operating the control circuit 95 to in turn operate the drive motor 70 for pivoting the support platform 12 from the first state to the second state so that the subject 2 is inverted on the support platform 12 with the head 3 of the subject 2 depending downwardly from the torso 4 of the subject.

If the subject 2 wishes to carry out leg exercises to exercise his or her leg, hip and abdominal muscles, the subject engages the foot engageable bar 78 of the foot engageable element 77 with his or her feet and urges the foot engageable element 77 in the direction of the arrow A against the force acting on the foot engageable element 77 by the weights 85. On the other hand, if the subject wishes to exercise his or her arms, chest, shoulder and back muscles, the subject grips the handgrips 86 and by pulling the handgrips 86 towards the subject, urges the carrier element 81 and in turn the weight carrying bar 84 as well as the foot engageable element 77 upwardly in the direction of the arrow A, thus raising the weights 85 in order to exercise the arm, shoulder, chest and back muscles. If desired, both the leg, hip and abdominal muscles as well as the arm, shoulder, chest and back muscles may be simultaneously exercised by engaging the feet on the foot engageable bar 78 and urging the foot engageable bar 78 in the direction of the arrow A, and by pulling the handgrips 86 towards the subject.

When the subject wishes to return the support platform 12 from the second state to the first state, the subject depresses the second control button switch 46 of the handheld control element 44 for in turn operating the control circuit 95 to operate the motor 70 for pivoting the support platform 12 from the second state to the first state.

While the plinths of the three apparatus have been described as comprising an upper framework and four or six ground engaging legs, any other suitable plinth or any other suitable mounting means may be provided for mounting the support platform to be pivotal between the first and second states.

While the support platforms of the three apparatus have been described and illustrated as being of a particular construction, any other suitable construction may be used.

While it is desirable, it is not essential that the torso and leg straps be provided, although in general, it is envisaged that a torso strap for securing the torso of a subject to the support platform would be required, needless to say, any other suitable securing means for securing a subject to the support platform may be provided.

It will also be appreciated that other shoulder engaging elements besides those described may be provided, and it will also be appreciated that any other suitable drive means besides a ram or a drive motor may be provided, for example, the drive means may comprise an electrically powered linear motor.

It is also envisaged that an opening may be formed in the support platform between the shoulder engaging elements adjacent the head and neck of the subject to provide access to the head and neck of the subject through the opening in the support platform for, for example, massaging the neck, head and face of the subject.

While the force applying means for applying a force to the foot engageable element have been described as being provided by compression springs and weights, it is envisaged that any other suitable resilient urging means may be provided, for example, it is envisaged that instead of or as well as weights and/or compression springs, an air spring or an hydraulic spring may be used, and in which case, it is envisaged that the air spring or the hydraulic spring as well as acting as the or one of the force applying means would also act as the guide means.

It is also envisaged that instead of the weight carrying bar extending longitudinally, it is envisaged that the weight carrying bar may extend transversely relative to the support platform, and where the weight carrying bar extends transversely relative to the support platform, it is envisaged that a pair of weight carrying bars may be provided, which would extend from the downwardly extending connecting member 82 on respective opposite sides thereof, so that the weights could be provided in a balanced nature on the respective transversely extending weight carrying bars, in order to be balanced around the downwardly extending connecting bar 82. It is also envisaged that the weights may be located above the support platform when the support platform is in the first state, and in which case the weights may, for example, be mounted directly onto the foot engageable bar.

Needless to say, any other suitable foot engageable element or elements for engaging the feet of the subject may be provided, and the foot engageable element or elements may be connected in any other suitable way to the force applying means.

Needless to say, any other suitable connecting means may be provided for coupling the handgrips to the foot engageable element or elements or to the weight carrying means.

It is also envisaged that while the drive means has been described as comprising an electrically powered motor, and the transmission means for transmitting drive from the electrically powered motor to the main pivot shaft in the apparatus 60 has been described as comprising a pinion gear directly driven by the electrically powered motor and a gearwheel mounted fast on the main pivot shaft, in certain cases, it is envisaged that the transmission means may comprise a stepdown gearbox, whereby the drive from the electrically powered motor would be stepped down, and the pinion gear for driving the gearwheel would be located on an output shaft from the stepdown gearbox. In practice, it is envisaged that the electrically powered drive motor and the gearbox would be provided as a single integral unit.

While the support platform has been described as being pivotally connected to the plinth, it is envisaged that the support platform may be connected to the plinth in any suitable manner so that the support platform is moveable between the first and second states. Indeed, in certain cases, it is envisaged that the support platform may be permanently and rigidly secured to any suitable mounting means or structure in the second state.

1-49. (canceled)

50. Apparatus for supporting a subject in a substantially inverted state, the apparatus comprising a support element comprising a pair of spaced apart shoulder engaging elements, the shoulder engaging elements being configured to support the subject in the substantially inverted state with the shoulder engaging elements substantially bearing the weight of the subject.

51. Apparatus as claimed in claim 50 in which the shoulder engaging elements define a neck accommodating space therebetween to freely accommodate the neck of the subject, and preferably, the shoulder engaging elements define a head accommodating space therebetween for freely accommodating movement of the head of the subject.

52. Apparatus as claimed in claim 50 in which each shoulder engaging element defines a shoulder accommodating recess for engaging and accommodating a corresponding one of the shoulders of the subject, and preferably, the shoulder accommodating recesses defined by the respective shoulder engaging elements define a shoulder axis which extends transversely of the support element, and advantageously, the shoulder engaging elements are located on the support element with the shoulder axis defined by the shoulder accommodating recesses extending in use substantially parallel to a line joining the shoulders of the subject.

53. Apparatus as claimed in claim 50 in which a securing means is provided for securing the torso of the subject to the support element, and preferably, the securing means comprises a torso engaging securing strap extending from the support element and configured for engaging the torso of the subject.

54. Apparatus as claimed in claim 50 in which the support element is operable between a first state configured to support the subject in a supine state, and a second state with the subject substantially inverted with the head of the subject depending downwardly from the torso of the subject and with the weight of the subject substantially supported by the shoulder engaging elements, and preferably, the support element is operable through an angle of approximately 90° between the first and second states, and advantageously, the support element is pivotal between the first state and the second state about a main pivot axis extending substantially parallel to the shoulder axis defined by the shoulder accommodating recesses of the shoulder engaging elements.

55. Apparatus as claimed in claim 50 in which a ground engaging mounting element is provided, and the support element is coupled to the mounting element and is operable relative to the mounting element between the first and second states, and preferably, the support element is pivotally coupled to the mounting element about the main pivot axis, and preferably, the mounting element is configured to support the support element in the first state with the support element at a height above the ground in the range of 500 mm to 900 mm, and advantageously, the mounting element is configured to support the support element in the first state with the support element at a height above the ground in the range of 600 mm to 800 mm, and ideally, the mounting element is configured to support the support element in the first state with the support element at a height above the ground of approximately 700 mm.

56. Apparatus as claimed in claim 55 in which the support element is pivotally coupled to the mounting element by a main shaft defining the main pivot axis.

57. Apparatus as claimed in claim 54 in which a drive means is provided for urging the support element between the first state and the second states, and preferably, the drive means comprises a drive motor mounted on one of the mounting element and the support element, and a drive transmission means is provided for transmitting drive from the drive motor to the other one of the mounting element and the support element, and advantageously, a control means is provided for controlling the operation of the drive means, and an interface means accessible to a subject on the support element is provided for inputting a signal to the control means for controlling operation of the drive means.

58. Apparatus as claimed in claim 50 in which the support element extends longitudinally between a head end and a foot end for receiving the subject with the head of the subject towards the head end, and the feet of the subject towards the foot end, and preferably, a head end portion of the support element extending from the main pivot axis and the head end of the support element extends beyond the mounting element, and preferably, the support element comprises an elongated platform extending between the head end and the foot end thereof.

59. Apparatus as claimed in claim 50 in which a foot engageable element is located on the support element spaced apart longitudinally from the shoulder engaging elements and is moveable in a general direction longitudinally towards and away from the shoulder engaging elements, and a force applying means is co-operable with the foot engageable element for applying a force to the foot engageable element acting in a general direction longitudinally towards the shoulder engaging elements.

60. Apparatus as claimed in claim 59 in which the foot engageable element is configured to be engageable by at least one foot of the subject so that the foot engageable element is urgeable by the foot of the subject in the general direction longitudinally away from the shoulder engaging elements against the force applied thereto by the force applying means, and preferably, the foot engageable element is configured to be engageable by the respective feet of the subject, and advantageously, a guide means mounted on the support element guides the foot engageable element in the general direction longitudinally towards and away from the shoulder engaging elements, and preferably, the foot engageable element is slideably mounted on the guide means and is slideable on the guide means in the general direction longitudinally towards and away from the shoulder engaging elements.

61. Apparatus as claimed in claim 59 in which the force applying means is configured to apply the force to the foot engageable element when the support element is in the second state, and preferably, the force applying means is adjustable for varying the force applied to the foot engageable element, and advantageously, the force applying means comprises a weight carrying element for selectively and releasably carrying one or more weights for providing the force to the foot engageable element, and preferably, the force applying means comprises a resilient element acting between the foot engageable element and the support element, and preferably, the resilient element comprises one of a mechanical spring, a pneumatic spring and an hydraulic spring.

62. Apparatus as claimed in claim 59 in which a connecting member extends between the foot engageable element and the force applying means for connecting the foot engageable element to the force applying means, and preferably, the force applying means is located beneath the support element, and a longitudinally extending elongated slot extends through the support element for accommodating the connecting member between the force applying means and the foot engageable element and to permit movement of the connecting element in the general direction longitudinally towards and away from the shoulder engaging elements.

63. Apparatus as claimed in claim 59 in which at least one handgrip configured to be gripped by one or both hands of the subject is connected to the force applying means, so that by one of pulling and pushing the at least one handgrip, the force applied by the force applying means is applied to the at least one handgrip for exercising muscles in the arm of the subject, and preferably, the at least one handgrip is connected to the force applying means by one of a flexible ligature and a rigid member, and advantageously, a pair of handgrips are provided, and preferably, each handgrip is connected to the force applying means.

64. Apparatus as claimed in claim 50 in which the shoulder engaging elements are adjustably mounted on the support element, and preferably, the shoulder engaging elements are selectively moveable in a generally longitudinal direction relative to the support element.

65. A method for supporting a subject in a substantially inverted state, the method comprising providing apparatus comprising a support element having a pair of shoulder engaging elements located on the support element, the shoulder engaging elements being configured to support the subject in the substantially inverted state, and locating the subject on the support element with the subject substantially inverted on the support element, with the shoulder engaging elements engaging the respective shoulders of the subject and substantially bearing the weight of the subject.

66. A method as claimed in claim 65 in which the subject is secured to the support element by a securing means, and preferably, the subject is secured to the support element by the securing means engaging the torso of the subject.

67. A method as claimed in claim 65 in which the support element is operable between a first state with the subject supported on the support element in a supine state, and a second state with the subject in the substantially inverted state with the head of the subject depending downwardly from the torso of the subject, and the subject is located on the support element with the support element in the first state prior to operating the support element from the first state to the second state, and preferably, the subject is secured to the support element with the support element in the first state and with the shoulders of the subject engaging the shoulder engaging elements.

68. A method for supporting a subject in a substantially inverted state in apparatus claimed in claim 50.

69. A method as claimed in claim 68 in which muscles in one of the legs of a subject on the support element are exercised by urging the foot engageable element by at least one foot of the subject against the force applied by the force applying means, and preferably, the muscles in an arm of a subject on the support element are exercised by one of pulling and pushing the at least one handgrip by one of the hands of the subject against the force applied by the applying means.
